(19) United States
(12) Patent Application Publication
(10) Pub. No.: US 2020/0376640 A1
(43) Pub. Date: Dec. 3, 2020

(54) FLOATING NAIL GUIDE GUN NOZZLE FOR NAIL GUN

(71) Applicant: SUPCO. PRODUCTS CO., Taichung City (TW)

(72) Inventor: Shih-Hung WANG, Taichung City (TW)

(21) Appl. No.: 16/429,763

(22) Filed: Jun. 3, 2019

(51) Int. Cl. B25C 5/02

(52) U.S. Cl. CPC B25C 5/0207

(57) ABSTRACT

A floating nail guide gun nozzle for nail a gun has a nail gun body, a gun nozzle holder located in the front end of the nail gun body, a linked cover plate located on the gun nozzle holder and an elastic reset mechanism located on the gun nozzle holder. A strutting bulge protrudes from the bottom surface of the front end of the linked cover plate, and the strutting bulge flares towards the front end of the linked cover plate and tilts down. The elastic reset mechanism enables the linking part to prop the strutting bulge of the linked cover plate against the gun nozzle holder without an external force.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates generally to a floating nail guide gun nozzle for a nail gun, and more particularly to an innovative structure using an elastic reset mechanism to assist the linked cover plate with fluctuation.

### 2. Description of Related Art Including Information Disclosed Under 37 CFR 1.97 and 37 CFR 1.98

Nails in many nail guns or staplers are U shaped. These U-shaped nails (or staples) can be vertically driven in the object, they are usually used for decorative woodwork or fixing objects.

The U-shaped nail is pushed instantaneously by the nail gun, so that the two nail pins of U-shaped nail are punched in the work object for stitching. As the two nail pins of U-shaped nail enter the work object in parallel, when the thickness of work object is smaller than the length of nail, the nail pins on both sides penetrate through the work object, leading to safety problems, and the U-shaped nail driven in vertically is likely to relatively slip or separate from the work object when it is pulled by an external force, it is difficult to implement steady combination.

For the aforesaid problems in the known nail gun structure, how to develop an innovative structure with more ideal practicability is what the users desire, as well as the objective and direction of research and development the related suppliers shall break through. In view of this, this inventor has years' experience in manufacturing, developing and designing related products, the present invention with practicability is obtained after detailed design and careful evaluation for the aforesaid objective.

### BRIEF SUMMARY OF THE INVENTION

The primary object of the present invention is to provide a floating nail guide gun nozzle for a nail gun. The technical problem to be solved is to break through how to develop a new type of structure with more ideal practicability.

Based on said purpose, the present invention provides a floating nail guide gun nozzle for nail gun, which comprises a nail gun body, a gun nozzle holder, which is located in the front end of the nail gun body, and a nail magazine is connected to the bottom of the gun nozzle holder; a linked cover plate, located on the gun nozzle holder, and a strutting bulge protrudes from the bottom surface of the front end of the linked cover plate, the strutting bulge flares towards the front end of the linked cover plate and tilts down; an elastic reset mechanism, located on the gun nozzle holder; the elastic reset mechanism has a linking part and an elastic reset part, the linking part is connected to the linked cover plate, and the elastic reset part is located on the linking part, so that the linking part props the strutting bulge of the linked cover plate against the gun nozzle holder without external force.

Another object of the present invention is to provide a guide slot in the back end of the gun nozzle holder, and a stopper protrudes from the back end of the linked cover plate, the stopper can slide in the guide slot, so as to enhance the stability of fluctuation of the linked cover plate.

### BRIEF DESCRIPTION OF THE SEVERAL VIEWS OF THE DRAWINGS

FIG. 1 is the three-dimensional outside view of the preferred embodiment of the present invention.

FIG. 2 is the three-dimensional exploded diagram of the preferred embodiment of the present invention.

FIG. 3 is the three-dimensional exploded diagram from another view angle of the preferred embodiment of the present invention.

FIG. 4A is the top view before the nail of the present invention is struck out.

FIG. 4B is the sectional view before the nail of the present invention is struck out.

FIG. 5 is the schematic diagram of the nail of the present invention expanding outwards.

FIG. 6A is the top view of the nail ejecting the linked cover plate in the present invention.

FIG. 6B is the sectional view of the nail ejecting the linked cover plate in the present invention.

### DETAILED DESCRIPTION OF THE INVENTION

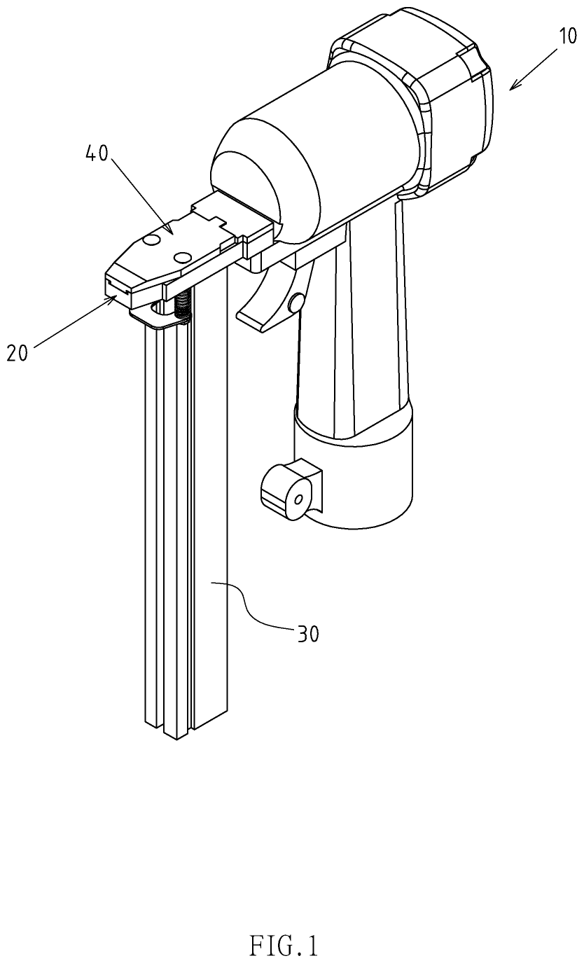

Referring to FIGS. 1, 2 and 3 for the preferred embodiments of the floating nail guide gun nozzle for a nail gun of the present invention, but the embodiments are for illustration only, the patent application is not limited to this structure.

Said floating nail guide gun nozzle for nail gun comprises a nail gun body 10; a gun nozzle holder 20, located in the front end of the nail gun body 10, and a nail output channel 20A is located in the top surface of the gun nozzle holder 20, a nail magazine 30 is connected to the bottom thereof, the nail magazine 30 holds the U-shaped nail 70; a linked cover plate 40, located on the gun nozzle holder 20, and a strutting bulge 41 protrudes from the bottom surface of the front end of the linked cover plate 40, the strutting bulge 41 flares towards the front end of the linked cover plate 40 and tilts down; an elastic reset mechanism 50 located on the gun nozzle holder 20, the elastic reset mechanism 50 has a linking part 51 and an elastic reset part 52, the linking part 51 is connected to the linked cover plate 40, and the elastic reset part 52 is located in the linking part 51, so that the linking part 51 props the strutting bulge 41 of the linked cover plate 40 against the gun nozzle holder 20 without an external force; in addition, the height difference between the highest end and the lowest end of the strutting bulge 41 is equal to or a little larger than the nail 70, a space equal to or a little larger than the thickness of the nail 70 is formed between the bottom surface of the linked cover plate 40 and the nail output channel 20A of the gun nozzle holder 20, so as to avoid the nail 70 rubbing against the bottom surface of the linked cover plate 40 and the nail output channel 20A of the nozzle holder 20 simultaneously when it is being struck out.

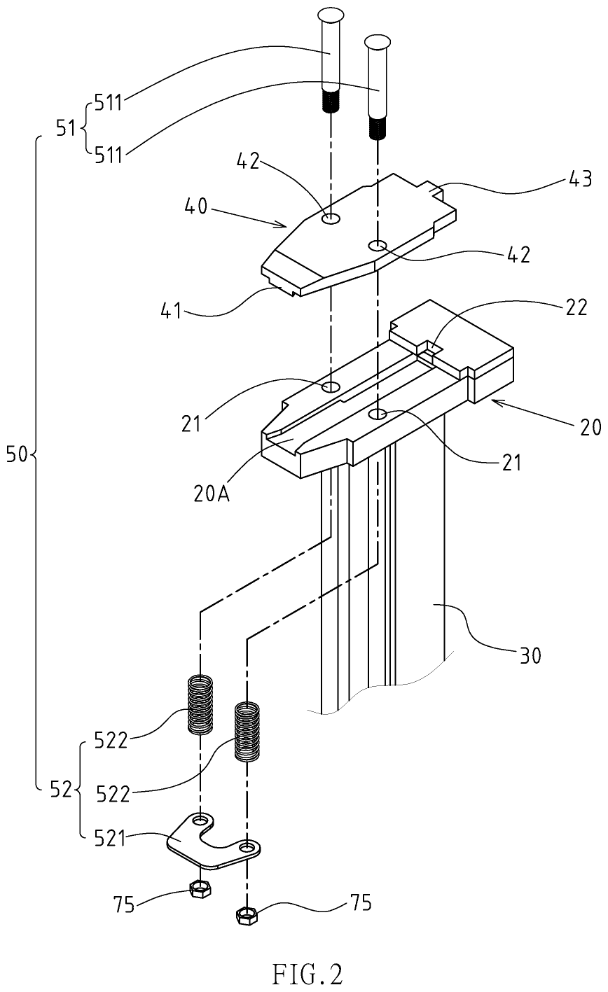

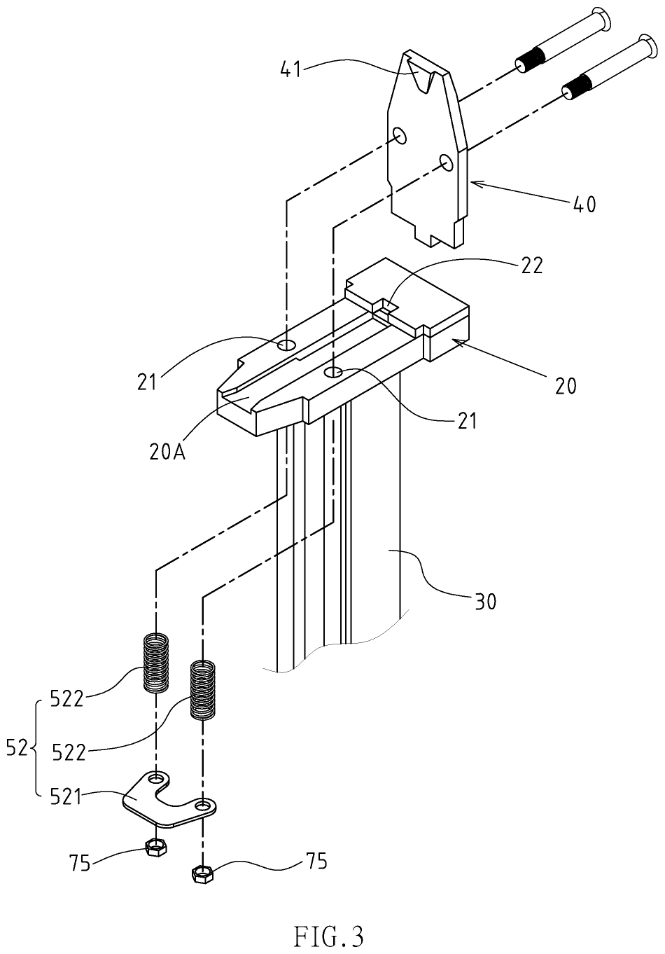

As shown in FIGS. 2 and 3, in this case, the gun nozzle holder 20 has a pair of bilaterally symmetric through holes 21, the linking part 51 has a pair of guide rods 511, and the elastic reset part 52 has a fixing plate 521 and a pair of elastic elements 522; the pair of guide rods 511 can slide in the pair of through holes 21, and both ends of each guide rod 511 are connected to the linked cover plate 40 and the fixing plate 521 respectively, the elastic element 522 is a spring, fitted over the guide rod 511, two ends of it prop the bottom surface of the gun nozzle holder 20 and the top surface of the fixing plate 521 respectively.

A pair of engagement holes 42 is located in said linked cover plate 40 corresponding to the pair of through holes 21. One end of the guide rod 511 engages with the engagement hole 42 of the linked cover plate 40, the other end is screwed in the fixing plate 521, and the screwed end is fastened by a nut 75. The characteristics of this design: at the screwed end of the guide rod 511, the amount of compression of the elastic element 522 (spring) can be adjusted by rotating the nut 75, so as to control the propping pressure of the linked cover plate 40 on the nozzle holder 20 (adjusted according to user requirement). To remove the linked cover plate 40 and the elastic reset mechanism 50, as long as the nut 75 is screwed off, the guide rod 511 can be withdrawn from the engagement hole 42. The assembly and disassembly are fast and convenient.

In this case, a guide slot 22 is located in the back end of the gun nozzle holder 20, a stopper 43 protrudes from the back end of the linked cover plate 40, the stopper 43 can slide in the guide slot 22.

According to the aforesaid structural composition and technical characteristics, the actuation of the present invention is described below:

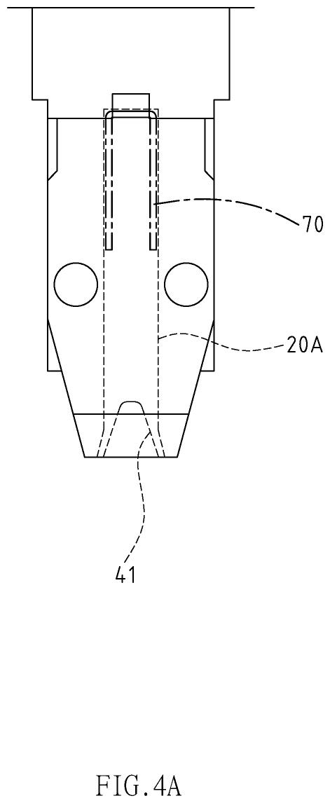

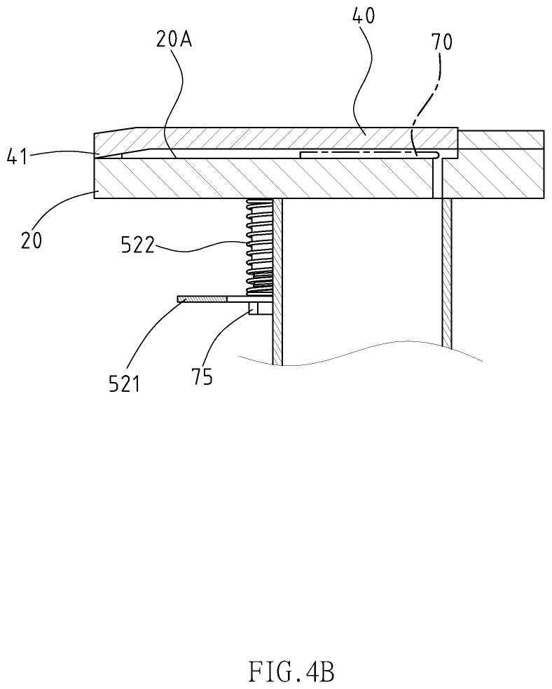

As shown in FIG. 4A and FIG. 4B, before the nail 70 is struck out, the strutting bulge 41 of the linked cover plate 40 props the nail output channel 20A of the gun nozzle holder 20, and the space formed between the bottom surface of the linked cover plate 40 and the nail output channel 20A of the gun nozzle holder 20 is a little larger than the thickness of the nail 70.

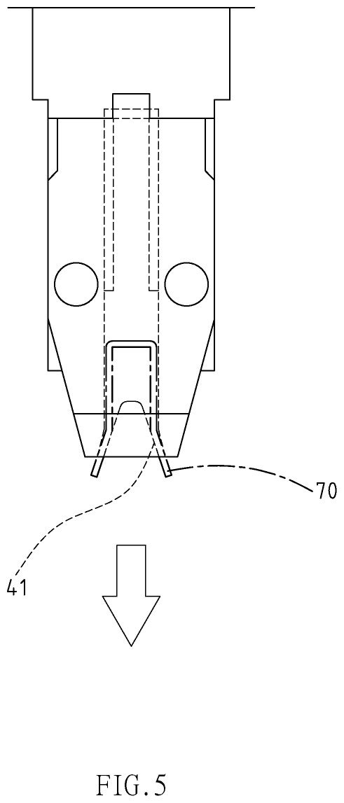

As shown in FIG. 5, when the nail 70 is struck out to contact the strutting bulge 41, the nail pins on both sides of the nail 70 expand outwards along the flaring shape of the strutting bulge 41, so as to form a splay.

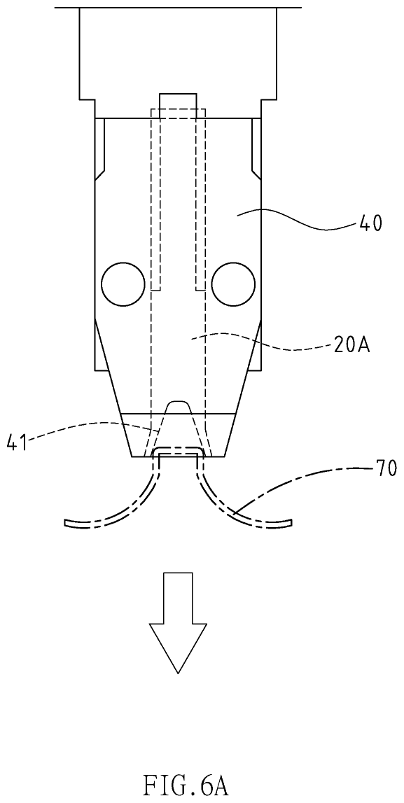

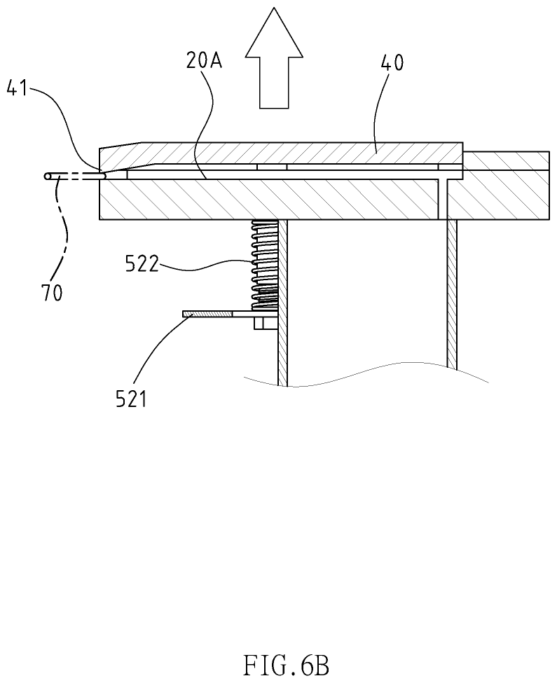

As shown in FIG. 6A and FIG. 6B, when the nail 70 continues moving forward and the end cross bar of the nail 70 contacts the strutting bulge 41, the end cross bar of the nail 70 pushes the linked cover part 40 up along the bevel face of the strutting bulge 41, and the fixing plate 521 is raised accordingly, the elastic element 522 is compressed slightly. Finally, the nail 70 moving forward is struck out as the strutting bulge 41 of the linked cover part 40 is separated from the nail output channel 20A of the gun nozzle holder 20 (the linked cover plate 40 is raised); certainly, when the nail 70 is struck out, the compressed elastic element 522 restores the state before compression, and ejects the fixing plate 521 down, the linked cover plate 40 moves down accordingly, and the strutting bulge 41 props the nail output channel 20A of the gun nozzle holder 20 (the linked cover plate 40 descends, the state in FIG. 6B is restored to that in FIG. 4B).

To sum up, the present invention makes the struck nail 70 into a splay flaring towards both sides, implementing steady combination in practice, and it is hard to be pulled out. In terms of actuation, the vertical movement of the linked cover plate 40 is guided by the pair of guide rods 511, which slide in the bilaterally symmetric pair of through holes 21, the linked cover plate 40 is kept balanced during fluctuation, preventing offset, and the stopper 43 restrains the slide in the guide slot 22, the overall actuation has good stability.

I claim:

1. A floating nail guide gun nozzle for a nail gun, comprising:
a nail gun body;
a gun nozzle holder, located in the front end of the nail gun body, and the bottom of the gun nozzle holder is connected to a nail magazine;
a linked cover plate, located on the gun nozzle holder, a strutting bulge protrudes from the bottom surface of the front end of the linked cover plate, the strutting bulge flares towards the front end of the linked cover plate and tilts down;
an elastic reset mechanism, located on the gun nozzle holder; the elastic reset mechanism has a linking part and an elastic reset part, the linking part is connected to the linked cover plate, and the elastic reset part is located on the linking part, so that the linking part props the strutting bulge of the linked cover plate against the gun nozzle holder without an external force.

2. The floating nail guide gun nozzle for nail gun defined in claim 1, wherein the gun nozzle holder has a pair of bilaterally symmetric through holes, the linking part has a pair of guide rods, the elastic reset part has a fixing plate and a pair of elastic elements; the pair of guide rods can slide in the pair of through holes, and two ends of each guide rod are connected to the linked cover plate and the fixing plate respectively, the elastic element is fitted over the guide rod, both ends prop the bottom surface of the gun nozzle holder and the top surface of the fixing plate respectively.

3. The floating nail guide gun nozzle for nail gun defined in claim 2, wherein one end of the guide rod engages with the linked cover plate, the other end is screwed in the fixing plate.

4. The floating nail guide gun nozzle for nail gun defined in claim 1, wherein a guide slot is located in the back end of the gun nozzle holder, a stopper protrudes from the back end of the linked cover plate, the stopper can slide in the guide slot.
